(19) United States
(12) Patent Application Publication
(10) Pub. No.: US 2011/0147624 A1
(43) Pub. Date: Jun. 23, 2011

(54) MAGNET VALVE WITH A VALVE HOUSING

(76) Inventors: Rene Schepp, Waiblingen (DE); Norbert Alaze, Markgroeningen (DE)

(21) Appl. No.: 12/976,439

(22) Filed: Dec. 22, 2010

(30) Foreign Application Priority Data
Dec. 22, 2009 (DE) 10 2009 055 174.3

(51) Int. Cl. F16K 31/08

(52) U.S. Cl. 251/65

(57) ABSTRACT

The invention relates to a magnet valve, having a valve housing in which a valve body provided with a valve seat is at least partly disposed. A valve tappet is supported longitudinally displaceably in the valve housing and cooperates with the valve seat. A sealing body is provided so as to sealingly close off the valve housing on one of its ends. According to the invention the valve housing has an axial ring rib, which sealingly axially engages an annular groove of the sealing body.

### CROSS-REFERENCE TO RELATED APPLICATION

This application is based on German Patent Application 10 2009 055 174.3 filed on Dec. 22, 2009.

### BACKGROUND OF THE INVENTION

1. Field of the Invention

The invention relates to a magnet valve, having a valve housing in which a valve body provided with a valve seat is at least partly disposed, and having a valve tappet, supported longitudinally displaceably in the valve housing and cooperating with the valve seat, and having a sealing body, which sealingly closes off the valve housing on one of its ends.

2. Description of the Prior Art

Magnet valves for disconnecting hydraulic circuits and for controlling and switching a medium in hydraulic circuits are known. For example, they are embodied as inlet valves that are open when without current and that have a valve housing (also called a valve insert), in which a valve body provided with a sealing seat is opened by a valve tappet, which is longitudinally displaceable in the valve housing and associated with a magnet armature and is kept open by a helical compression spring by the imposition of force, or on being supplied with current is closed by longitudinal displacement of the magnet armature and of the valve tappet associated with it. This kind of valve housing is closed and sealed off on one end by a closure cap, which embraces the pole core and in turn, in operation of the valve assembly, is embraced by an electromagnet for introducing electromagnetic field forces. On the opposite end, a valve housing of this kind is sealingly closed off by a sealing body. Embodiments are known in which the inflow of the hydraulic circuit medium to be switched takes place axially through inflow openings in the sealing body, and the outflow takes place radially through outflow openings in the valve housing. A magnet valve of this kind is inserted into a hydraulic block by its end remote from the pole core, and in particular by the sealing body. The sealing body, for the sake of simple production and for reasons of cost, is embodied as a molded plastic part, which has a sealing lip that seals off the sealing body from the outside, in particular from the hydraulic block. In the sealing body, a check valve, for instance in the form of a ball valve, is provided, which in an overflow of the valve counter to its intended direction of operation protects against high pressure peaks of the hydraulic circuit to be switched in the vicinity of the plastic sealing element and where it is joined to the valve housing; an excessively high pressure cannot occur in these regions, because of the closure of the check valve. Pressure peaks caused by closure of the magnet valve can be intercepted into the inflow region via the check valve, for which purpose a relief bore to the inflow region is provided in the vicinity of the check valve. Such valves can be operated only in an intended flow direction and are relatively complicated, particularly because the check valve described is required.

### SUMMARY OF THE INVENTION

The disadvantages described can be advantageously avoided by the invention. To that end, the invention relates to a magnet valve is proposed, having a valve housing in which a valve body provided with a valve seat is at least partly disposed, and having a valve tappet, supported longitudinally displaceably in the valve housing and cooperating with the valve seat, and having a sealing body, which sealingly closes off the valve housing on one of its ends. It is provided that the valve housing has an axial ring rib, which sealingly axially engages an annular groove of the sealing body. Because of the embodiment of the connection of the sealing body to the valve housing by means of the axial ring rib engaging the annular groove, a compressive strength of the connection between the sealing body and the valve housing when there is a flow in both directions is ensured. Particularly the use of the magnet valve as a disconnection valve, for instance in. ESP applications, necessitates the two-sided seal and two-sided flowability. Unlike in the prior art, this is ensured with the proposed embodiment. In this embodiment, a pressure exerted from inside in the vicinity of the valve body is maintained by an inner leg of the annular groove that is braced in the radial direction from the outside internally on the axial ring rib, and a pressure exerted from outside is maintained by an outer leg of the axial ring rib that is braced in the radial direction inward on the outside of the axial ring rib. All in all, the magnet valve is introduced into the hydraulic circuit, namely into a receiving bore in the hydraulic circuit for the magnet valve, in the vicinity of the sealing body, and in particular in the vicinity of the axial ring rib and the annular groove, so that once again, radial bracing toward the outside is provided.

In a further embodiment, it is provided that a seal is disposed in the bottom of the annular groove. This seal effects a solid, tolerance-free fit of the valve housing in the sealing body, especially in the final built-in state of the magnet valve in the receiving bore in the hydraulic block. At the same time, good axial sealing is accomplished between the valve housing and the sealing body in the vicinity of the axial ring rib and the annular groove.

Preferably, it is provided that the seal is integrally injection-molded onto the sealing body, which preferably comprises plastic. As in the prior art, the sealing body should preferably comprise plastic, since in this way, as a molded plastic part, it can easily be produced comparatively favorably and with complicated geometries. Moreover, it is possible by way of the selection of suitable plastics and their particular specifications to adapt the sealing body in terms of its properties quite precisely to the intended use of the magnet valve, or in other words for instance to lend it especially good thermal stability and/or good dimensional stability and/or further desired properties. The seal is integrally injection molded onto this sealing body, so that a permanent connection with precise positioning of the seal on the sealing body is the result.

It is especially preferred that the seal is an elastically or plastically deformable seal. Elastic deformability, because of the restoring action of the elastic deformation, has a self-sealing effect, and the plastic deformation, particularly during assembly, enables very good, lasting adaptation between the seal and the valve housing. In the embodiment as a plastically deformable seal, it can be provided in particular that the seal is embodied for instance as nubs, which in the assembly of the valve plastically deform the plastic sealing body to a limited extent and in the process, precisely because of this plastic deformation, which is due to the press-fitting force/assembly force, adapt it in its geometry to the available installation space in the hydraulic block receiving bore. In this way, a very particularly good seal and a practically entirely play-free seat in the receiving bore in the hydraulic block are achieved. To avoid a further, unwanted deformation of the nubs during magnet valve operation, care should be taken that the assembly force for the deformation during assembly be markedly greater than the hydraulic force acting on the sealing body during operation.

In a further preferred embodiment, the annular groove of the sealing body is bounded on the outside by a sealing lip and on the inside by a sealing ring rib. The annular groove of the sealing body is accordingly embodied such that the legs of the groove are embodied on the outside as a sealing lip and on the inside as a sealing ring rib. What is essential here is the sealing action originating at the sealing lip and the sealing ring rib, which is effected for instance by suitable material properties, such as elastic deformability or the nature of the surface.

It is also provided that the sealing lip overlaps the outer jacket face of the valve housing. As a result of this overlap, the sealing action between the sealing lip and the outer jacket face of the valve housing is established, especially whenever the overlap in the axial direction is effected over a not inconsiderable axial portion, in an end region of the radial annular rib.

It is furthermore provided that the sealing ring rib axially engages an annular chamber embodied between the valve housing and the valve body. Between the valve housing and the valve body, the annular chamber is provided for the engagement of the sealing ring rib, and this annular chamber is preferably embodied such that upon full engagement, the annular chamber is essentially completely filled by the sealing ring rib, so that once again, a sealing action in the radial direction ensues both outward and inward. The sealing ring rib can be braced here in both directions on side walls of the annular chamber and as a result has an especially pressure-proof sealing effect. The imposition of pressure in a radial direction causes the sealing ring rib to contact and be braced on the particular wall of the annular chamber located in the pressure direction, so that the sealing takes place in each case in that direction. Given a suitable material property of the sealing ring rib, the sealing action even increases with increasing pressure.

In a preferred embodiment, it is provided that the sealing body comprises a first sealing element and a second sealing element, and the first sealing element has the sealing lip and the sealing ring rib, and the second sealing element is slipped axially onto the first sealing element. The sealing body is accordingly embodied in two parts. The first sealing element has the elements described above, that is, the sealing lip and the sealing ring rib, and seals off from the valve housing. The second sealing element is slipped onto this aforementioned first sealing element in the axial direction, namely on a side of the first sealing element opposite from the valve housing.

It is furthermore provided that the first sealing element has a central protrusion, which an annular wall of the second sealing element overlaps axially. This is essentially a plug-type combination, of the kind familiar for instance as peg construction. The central protrusion of the first sealing element engages the second sealing element in the axial direction and is overlapped axially by the annular wall of the second sealing element, so that in the radial direction, a wall face contact ensues between the central protrusion and the annular wall, thereby bringing about a sealing action on the one hand and the holding together of the two sealing elements on the other. The second sealing element, in the vicinity of its bottom, has at least one through opening for the medium to be switched, and the through opening acts as an inflow opening or outflow opening, depending on the direction of operation of the magnet valve. This through opening corresponds with a fluidic continuation that is disposed in the first sealing element and enables the flow from the first sealing element and the second sealing element, or in other words the entire sealing body, in the intended way as far as the valve seat in the valve body.

It is preferably provided that the first sealing element is preferably radially pressed and/or welded to the second sealing element in the vicinity of the central protrusion and annular wall. The holding together of the first and second sealing elements for embodying the sealing body is effected, as already mentioned, by wall contact in the vicinity of the central protrusion and of the annular wall. To secure the connection of the two sealing elements, they can be pressed in this vicinity, and in particular, pressed radially and/or welded. The welding is especially preferably done in the form of ultrasonic welding. In this way, a permanent connection, under the intended conditions of use, of the two sealing elements for embodying the sealing body is accomplished. Particularly in the deformation of the sealing body during the assembly, as already described above, for embodying a very precise fit in the receiving bore of the hydraulic block, the secure, intimate connection of the first sealing element and second sealing element is essential, in order to avoid unwanted sliding apart during the plastic deformation of the sealing body during the assembly.

Especially preferably, the second sealing element has a filter element for a medium that is to be switched by the magnet valve. Because the second sealing element is a molded plastic part, additional components, such as the filter element can be introduced quite simply during the production of the second sealing element. Especially if the magnet valve is used for a flow in both flow directions, or in other words whenever neither an exclusive inflow opening nor an exclusive outflow opening is provided, but rather an inflow opening can also serve as an outflow opening and vice versa, the use of such a filter element is appropriate, in order to secure the magnet valve, and in particular the valve seat, in both directions against foreign bodies that may be present in the medium that is to be switched. The filter element is especially preferably disposed in the through opening that is provided in the second sealing element, and in particular in the bottom of the second sealing element.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 is a simplified sectional view of a magnet valve with a valve housing and a sealing body; and

FIG. 2 shows a detail of the sealing body.

### DESCRIPTION OF THE PREFERRED EMBODIMENT

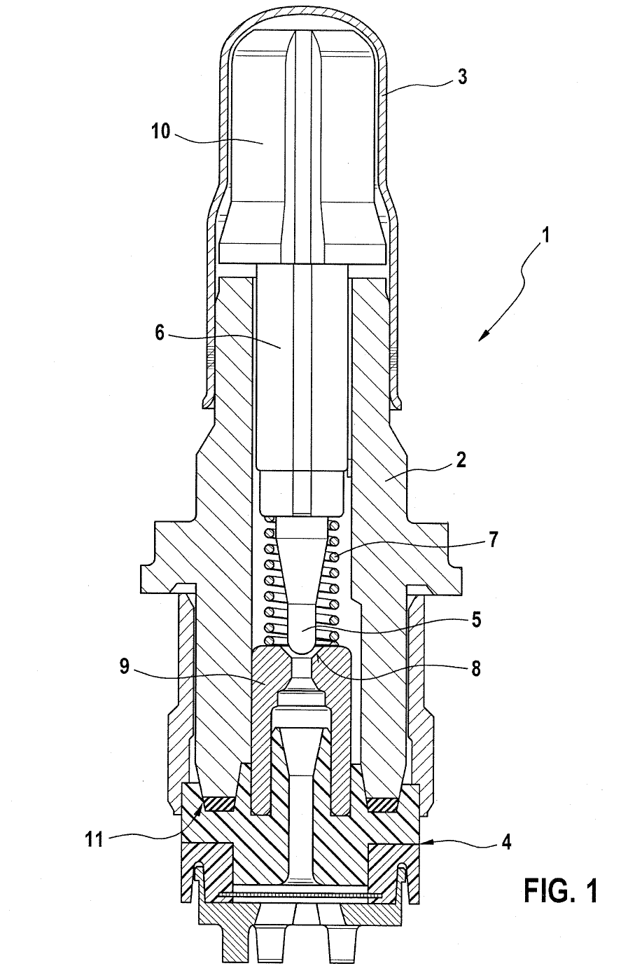

FIG. 1 shows a magnet valve 1, with a valve housing 2 that is closed off in sealing fashion on the top by a housing cap 3 and on the bottom by a sealing body 4. A valve tappet 5 is supported longitudinally displaceably inside the valve housing 2 and cooperates with a magnet armature 6, axially adjoining the housing cap 3, and a helical compression spring 7 embracing the valve tappet 5; the helical compression spring 7 is braced on one end on the magnet armature 6 and on a valve body 9, which is axially adjacent to the valve tappet 5 and has a valve seat 8 that is to be opened and closed by the valve tappet 5. The valve housing 2 is embodied as essentially hollow-cylindrical, for receiving the magnet armature 6, the valve tappet 5 adjoining the magnet armature, the valve body 9 adjoining the valve tappet and having the valve seat 8, and a pole core 10, which faces the magnet armature 6 and is on the opposite end from the valve tappet 5 and which the housing cap 3 of the valve housing 2 overlaps. The sealing body 4 engages a lower end 11 of the valve housing 2 and closes off its hollow-cylindrical embodiment in sealing fashion at the bottom. The sealing body 4 is shown here only as an example.

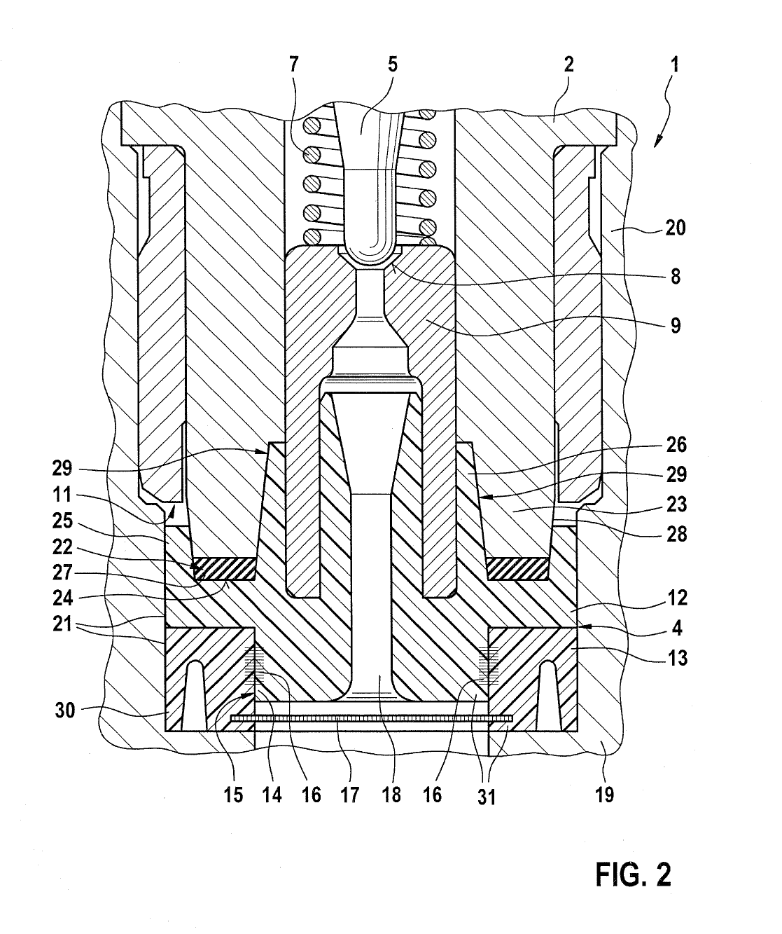

FIG. 2 shows the sealing body 4 in detail, thrust axially onto the lower end 11 of the valve housing 2. The sealing body 4 is embodied in two parts, namely a first sealing element 12 and a second sealing element 13; the second sealing element 13 is slipped axially on the end onto the first sealing element 12. For that purpose, the first sealing element 12 has a central protrusion 14 essentially in the middle, and this central protrusion is embraced by an annular wall 15 of the second sealing element 13. The first sealing element 12 and the second sealing element 13 are radially pressed and additionally welded, preferably by ultrasonic welding, in the vicinity of the central protrusion 14 and the annular wall 15, so that a holding zone 16 is embodied in which the first sealing element 12 and the second sealing element 13 are held in captive fashion against one another, to embody the sealing body 4. On the bottom of the second sealing element 13, opposite the central protrusion 14 of the first sealing element 12, a filter element 17 is introduced, which serves to filter a medium, not shown here, as it enters the magnet valve 1 (see FIG. 1) through the filter element 17 in flow conduits 18 in the sealing body 4.

In the installed position shown in FIG. 2, the magnet valve 1 has been inserted into a pump housing 19, so that the sealing body 4 and a portion of the valve housing 2 are embraced by a valve receptacle 20 of the pump housing 19. The valve receptacle 20 here acts on the sealing body 4 in the vicinity of outer walls 21 of both the first sealing element 12 and the second sealing element 13 and in at least some portions on the bottom of the second sealing element 13 as well. The first sealing element 12 has an axial annular groove 22, pointing in the direction of the valve housing 2, which is engaged by an axial ring rib 23 that is formed on the end of the valve housing 2. The annular groove 22 comprises a groove bottom 24 and a sealing element 25, defining the annular groove 22 on the outside, as well as a sealing ring rib 26 defining the annular groove 22 on the inside, or in other words in the direction toward the valve body 9. A sealing means 27 is introduced onto the groove bottom 24 of the annular groove 22, preferably being integrally injection molded onto it. The sealing means 27 is embodied as a plastically deformable sealing means. When the valve housing 2 and the sealing body 4 are axially joined together, or in other words when the axial ring rib 23 is inserted into the annular groove 22, this sealing means 27 is plastically deformed to a slight extent and ensures a play-free fit of the valve housing 2 on the first sealing element 12. The sealing lip 25 provides sealing between an outer jacket face 28 of the valve housing 2, which face the sealing lip 25 overlaps for the purpose, and the valve seat 8. The sealing ring rib 26 provides sealing between the valve housing 2 and the valve body 9, for which purpose, between the valve housing 2 and the valve body 9, an annular chamber 29 is embodied, which is engaged as completely as possible by the sealing ring rib 26, or in other words with full utilization of the available space in the annular chamber 29. The sealing lip 25 and the sealing ring rib 26 here are both embodied on the first sealing element 12. It is preferably provided that an outer sealing lip 30 is provided on the second sealing element 13, with the same orientation as the axial ring rib 23, or in other words in the direction toward the underside of the second sealing element, and this outer sealing lip urges the second sealing element against the valve receptacle 20, preferably with slight initial tension. The sealing body 4, and specifically both the first sealing element 12 and the second sealing element 13, are preferably made from the same kind of plastic 31. In this way, a complicated geometry can be fabricated comparatively inexpensively. Because of the bracing on the valve body 9, the axial ring rib 23 and the valve receptacle 20, compressive strength is ensured in all radial directions, that is, oriented both outward and inward. Even under changing flow directions and pressure directions in the magnet valve 1, and particularly with flows through the flow conduit 18 in the different directions, the sealing element 25 and the sealing ring rib 26 provide secure sealing. Toward the outside, that is, toward the valve receptacle 20, a further secure seal is effected by the sealing lip 25 and the outer sealing lip 30. Given a suitable, sufficiently strong press-fitting force, for securing the magnet valve 1 in the valve receptacle 20, the sealing means 27 will also deform the sealing body 4 slightly in such a way, by subjecting the bottom 24 of the annular groove 22 to force, that the first sealing element 12 and second sealing element 13 that comprise plastic 31 fill the valve receptacle 20 as completely as possible, each contacting the walls over the full surface. In this way, a tight, play-free seat is ensured.

The foregoing relates to a preferred exemplary embodiment of the invention, it being understood that other variants and embodiments thereof are possible within the spirit and scope of the invention, the latter being defined by the appended claims.

We claim:

1. A magnet valve, comprising:
a valve housing in which a valve body provided with a valve seat is at least partly disposed;
a valve tappet, supported longitudinally displaceably in the valve housing and cooperating with the valve seat; and
a sealing body, which sealingly closes off the valve housing on one end thereof, wherein the valve housing has an axial ring rib, which sealingly axially engages an annular groove of the sealing body.

2. The magnet valve as defined by claim 1, wherein a sealing element is disposed in the groove bottom of the annular groove.

3. The magnet valve as defined by claim 1, wherein the sealing element is integrally injection-molded onto the sealing body, which preferably comprises plastic.

4. The magnet valve as defined by claim 2, wherein the sealing element is integrally injection-molded onto the sealing body, which preferably comprises plastic.

5. The magnet valve as defined by claim 1, wherein the sealing element is an elastically or plastically deformable sealing element.

6. The magnet valve as defined by claim 2, wherein the sealing element is an elastically or plastically deformable sealing element.

7. The magnet valve as defined by claim 3, wherein the sealing element is an elastically or plastically deformable sealing element.

8. The magnet valve as defined by claim 1, wherein the annular groove of the sealing body is bounded on its outside by a sealing lip and on its inside by a sealing ring rib.

9. The magnet valve as defined by claim 8, wherein the sealing lip overlaps an outer jacket face of the valve housing.

10. The magnet valve as defined by claim 8, wherein the sealing ring rib axially engages an annular chamber embodied between the valve housing and the valve body.

11. The magnet valve as defined by claim 9, wherein the sealing ring rib axially engages an annular chamber embodied between the valve housing and the valve body.

12. The magnet valve as defined by claim 8, wherein the sealing body comprises a first sealing element and a second sealing element, and the first sealing element has the sealing lip and the sealing ring rib, and the second sealing element is slipped axially onto the first sealing element.

13. The magnet valve as defined by claim 9, wherein the sealing body comprises a first sealing element and a second sealing element, and the first sealing element has the sealing lip and the sealing ring rib, and the second sealing element is slipped axially onto the first sealing element.

14. The magnet valve as defined by claim 10, wherein the sealing body comprises a first sealing element and a second sealing element, and the first sealing element has the sealing lip and the sealing ring rib, and the second sealing element is slipped axially onto the first sealing element.

15. The magnet valve as defined by claim 12, wherein the first sealing element has a central protrusion, which is overlapped axially by an annular wall of the second sealing element.

16. The magnet valve as defined by claim 12, wherein the first sealing element is preferably radially pressed and/or welded to the second sealing element in the vicinity of the central protrusion and annular wall.

17. The magnet valve as defined by claim 15, wherein the first sealing element is preferably radially pressed and/or welded to the second sealing element in the vicinity of the central protrusion and annular wall.

18. The magnet valve as defined by claim 12, wherein the second sealing element has a filter element for a medium that is to be switched by the magnet valve.

19. The magnet valve as defined by claim 15, wherein the second sealing element has a filter element for a medium that is to be switched by the magnet valve.

20. The magnet valve as defined by claim 16, wherein the second sealing element has a filter element for a medium that is to be switched by the magnet valve.
